(19) United States
(12) Patent Application Publication
(10) Pub. No.: US 2012/0213901 A1
(43) Pub. Date: Aug. 23, 2012

(54) Food Warmer and Cooker Apparatus with Basket Inserts

(76) Inventors: Emanuel A. Kyris, East Hartford, CT (US); Jared Raymond Simpson, Vernon, CT (US)

(21) Appl. No.: 13/397,725

(22) Filed: Feb. 16, 2012

Related U.S. Application Data
(60) Provisional application No. 61/463,624, filed on Feb. 22, 2011.

(51) Int. Cl. A47J 27/12; A23L 1/01

(52) U.S. Cl. 426/509; 99/340

(57) ABSTRACT

A food apparatus (10) for warming and cooking foodstuff is comprised of a container (12), container sidewalls (14), a container base (16), and handles (18). Basket inserts (20) with basket handles (30) hold foodstuff and may be submerged into hot liquid inside of the container (12) or set to rest on the edge of the front container sidewall (14) by an angled clip (36). The basket handles (30) face in the direction of the operator for ease of use. Sidewall mesh (26) and bottom mesh (28) holds foodstuff inside the basket insert (20), allowing hot liquid to enter and warm or cook foodstuff. Upon lifting the basket insert (20) from the container (12), the sidewall mesh (26) and bottom mesh (28) allow liquid to escape from the basket insert (20) while holding the foodstuff inside the basket insert (20).

### CROSS-REFERENCE TO RELATED APPLICATIONS

This application claims the benefit of provisional patent application Ser. No. 61/463,624 filed 2011 Feb. 22 by the present inventors.

### BACKGROUND

This application relates to a stovetop warming and cooking apparatus with basket inserts for use with foodstuff.

### PRIOR ART

The following is a tabulation of some prior art that presently appears relevant:

U.S. Patents

| Pat. No. | Issue Date | Patentee |
|---|---|---|
| 5,385,084 | 1995-01-31 | Laibson |
| 3,958,503 | 1976-05-26 | Moore |
| 6,063,421 | 2000-05-16 | Barravecchio |
| 6,732,636 | 2004-05-11 | Germano |
| 1,745,243 | 1930-01-30 | Boyle |
| 5,992,306 | 1999-11-30 | Chiang |
| 4,854,227 | 1989-08-08 | Koopman |
| 5,515,990 | 1996-05-14 | Popeil, Backus |
| 3,894,483 | 1975-07-15 | Anetsberger, et al |
| 3,960,137 | 1976-06-01 | Schmid |
| 5,033,369 | 1991-07-23 | Wu |
| 7,926,416 | 2011-04-19 | Acanto S.R.L. |
| 4,214,514 | 1980-07-29 | Contino, et al |
| 4,569,277 | 1986-02-11 | Stiglich |
| 4,803,917 | 1989-02-14 | Barbieri |
| 5,241,899 | 1993-09-07 | Kuhlman |
| 5,313,876 | 1994-05-24 | Hilger et al |
| 5,351,605 | 1994-10-04 | Keishu Sai et al |
| 5,361,684 | 1994-11-08 | Cattaneo |
| 5,365,831 | 1994-11-22 | Kuhlman |
| 5,542,344 | 1996-08-06 | Koether et al |
| 5,586,487 | 1996-12-24 | Marino |
| 5,609,093 | 1997-03-11 | Hohler et al |
| 5,613,423 | 1997-03-25 | Polster |

### Nonpatent Literature Documents

Tiger Chef website, “Thunder Group ALSKPC005 5 Piece Aluminum Pasta Cooker” (Dec. 13, 2011) http://www.tigerchef.com/thunder-group-alskpc005-5-piece.html
Winco/DWL Industries website, “Pasta Cookers” (Dec. 13, 2011) http://www.wincous.com/ProductShow.asp?ID=66

Restaurants commonly precook pasta and warm it up per order. In addition, restaurants cook or warm fresh and/or frozen pasta foods. Other foods, such as vegetables, also need to be warmed or cooked in an efficient and timely manner.

Restaurants that have the space and/or financial means may use a gas or electric pasta cookers to warm or cook food. Restaurants with a limited budget and/or limited space may use other methods to warm or cook food, such as microwaves or stovetop pasta cookers.

The following U.S. patents can or do act as pasta/foodstuff warmers or cookers: U.S. Pat. Nos. 3,894,483 (1975), 3,960,137 (1976), 5,033,369 (1991), 7,926,416 (2011), 4,214,514 (1980), 4,569,277 (1986), 4,803,917 (1989), 5,241,899 (1993), 5,313,876 (1994), 5,351,605 (1994), 5,361,684 (1994), 5,365,831 (1994), 5,542,344 (1996), 5,586,487 (1996), 5,609,093 (1997), 5,613,423 (1997). Many of these prior art inventions are stand-alone units that require their own gas or electrical hookups. Other prior art inventions have features that go beyond the needs of the average restaurant. These units are effective at warming or cooking foodstuff, but can be expensive and require additional space.

U.S. Pat. No. 5,385,084 offers a cooking apparatus that drains spent and starchy water and replaces it with fresh water. The components necessary to dispose of and add water, as well as the need for a nearby drain and water source, however, limit the number of restaurants that can use the apparatus for a number of reasons:

(a) The apparatus' need for a suitable water supply and for a drain in close proximity to a restaurant's stove would require ill-equipped restaurants to perform potentially costly plumbing modifications to their kitchen, such as installing a drain or adding pipes/hoses for the water supply.

(b) The apparatus lacks flexibility, whereby restaurant renovations would need to account for the proper placement of a water supply and drain for the apparatus to function as intended.

(c) The movement of the apparatus from one stovetop burner to another may be limited, whereby the proximity of a restaurant's water supply and/or drain can place a limit on which stovetop burners the apparatus can function as intended. This can cause an issue if a stovetop burner suddenly malfunctions or if the cook needs to maneuver various cooking apparatus' on the stovetop.

Round pasta cookers with four basket inserts currently on the market, including Winco/DWL Industries' Pasta Cooker, Thunder Group's ALSKPC005 5 Piece Aluminum Pasta Cooker, and other identical cookers produced by competing manufactures, offer an economical means to warm and cook foodstuff. These pasta cookers, however, fall short of providing an efficient means to warm and cook foodstuff. We have found a number of disadvantages from the current pasta cookers on the market, both from our own experience and the experience of other professional cooks:

(a) The above mentioned pasta cookers are designed for use on a single stovetop burner. The size of these pasta cookers, however, extends beyond the dimensions of a single standard commercial stovetop burner. As a result, adjacent stovetop burners are partially covered by the pasta cooker and make it difficult or impossible to utilize the adjacent burners.

(b) The basket inserts that hold foodstuff and fit into current pasta cookers face in four different directions. Removing or returning the baskets to the pasta cooker, in particular the two rear baskets, can be cumbersome in a fast-paced environment.

(c) The basket insert handles' proximity to adjacent stovetop burners can result in hot handles, whereby the handles overhang stovetop burners that are potentially being used to heat other foodstuff. This poses the potential for bodily harm as the cook can easily burn himself/herself.

(d) Basket inserts residing in the pasta cooker can shift around when one of the four basket inserts is removed. The round shape of the pasta cooker, combined with the triangular shape of the basket insert, can make it difficult to return the fourth basket insert to the pasta cooker.

(e) The basket inserts have clips on the bottom that are used for attaching the basket to the rim of the pasta cooker when the basket insert is not in use or is draining water. Many of these clips are flimsy and difficult to affix to the round pasta cooker, especially in a fast-paced environment.

(f) The basket inserts have a number of round holes on all sides that allow water to drain from the basket. Due to the size of these holes, thin pastas such as spaghetti, angel hair, and orzo can escape through these holes and fall on the ground or into the pasta cooker's water.

Deep fryer basket inserts and pasta basket inserts come in many shapes and sizes. The following U.S. patents act in a manner that can warm or cook foods: U.S. Pat. Nos. 6,732,636 (2004), 5,992,306 (1999), 4,854,227 (1989). The holes in the aforementioned basket inserts, however, are too large for thin foodstuff, whereby the foodstuff can fall through the basket insert's holes.

### SUMMARY

In accordance with one embodiment a portable cooking apparatus comprises a cooking container with sidewalls, a bottom, handles, and basket inserts with mesh material for warming and cooking foodstuff.

### ADVANTAGES

Accordingly several advantages of one or more aspects are as follows: an apparatus that is relatively inexpensive, an apparatus that requires a single stovetop burner and no other modifications to the kitchen, an apparatus with a size and shape that conforms to a standard commercial stovetop burner, basket inserts that face in the same direction as the operator, basket inserts that are easy to remove from and return to the cooking apparatus, basket inserts that are easy to reach, basket inserts that provide a clip that is safe and easy to affix to the apparatus, basket inserts that have holes/mesh that allow liquid to drain but retains thin foodstuff. Other advantages of one or more aspects will be apparent from a consideration of the drawings and ensuring description.

### DRAWINGS

### Figures

In the drawings, closely related figures have the same number but different alphabetic suffixes.

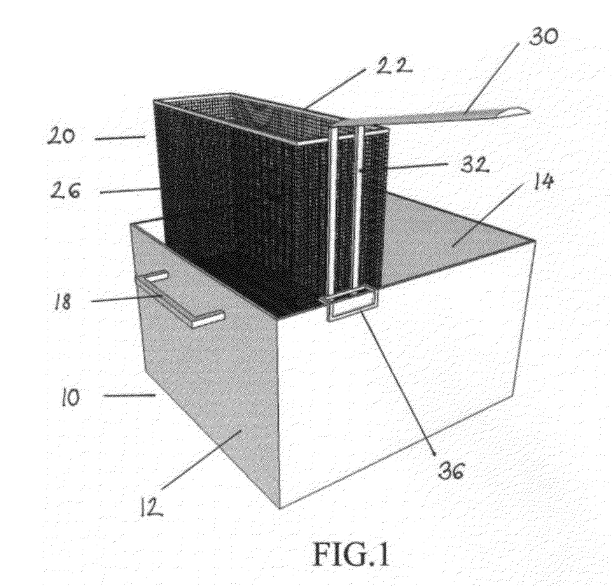

FIG. 1 shows the food apparatus with the basket insert affixed to the container by the basket insert's clip.

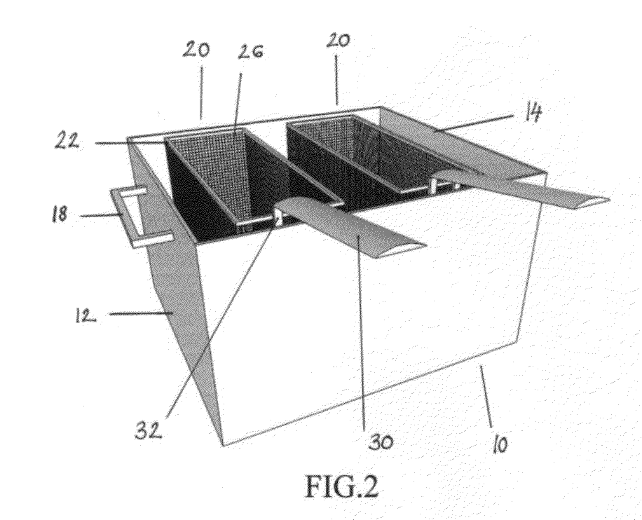

FIG. 2 shows the food apparatus with a pair of basket inserts submerged in the container.

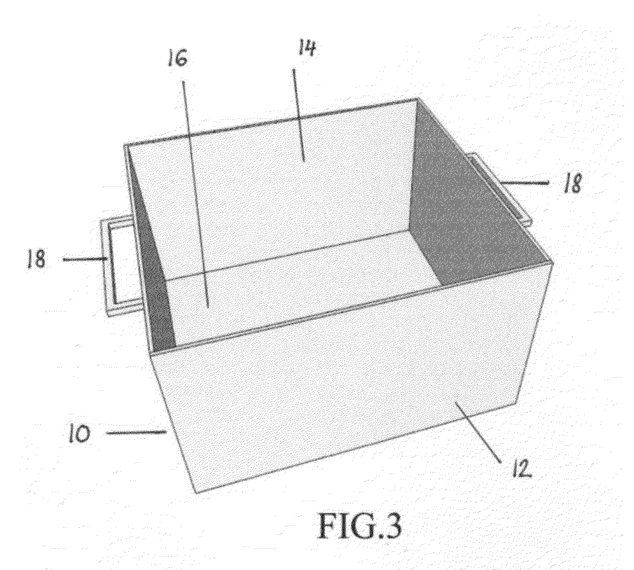

FIG. 3 shows the food apparatus' container.

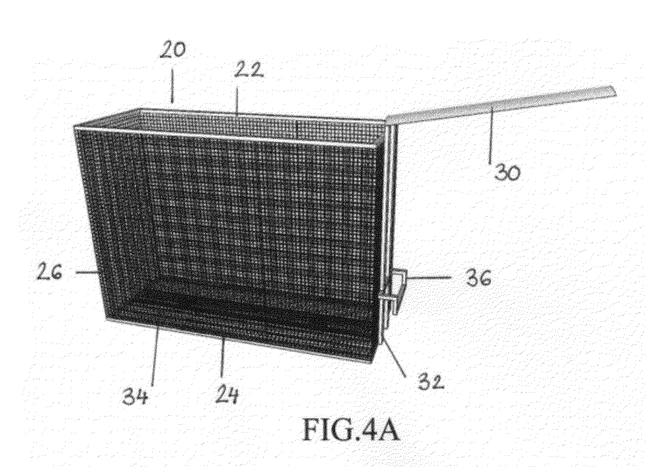

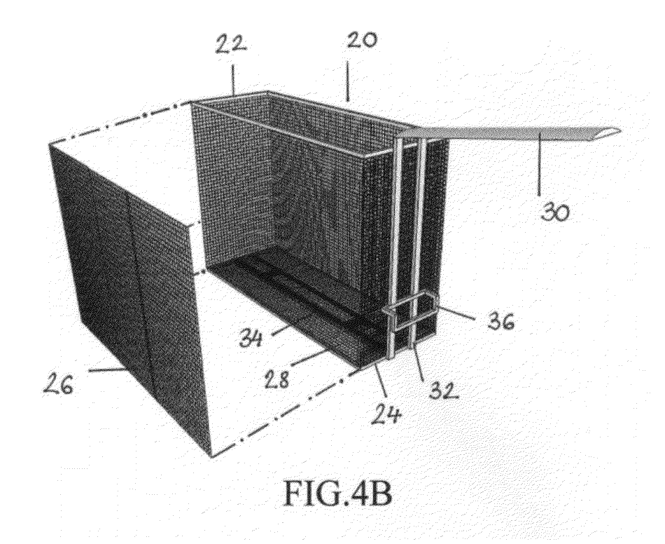

FIGS. 4A to 4B show the side view of the food apparatus' basket insert, along with an explode view that shows the basket insert's bottom bracket.

DRAWINGS - REFERENCE NUMERALS

| | |
|---|---|
| 10 | food apparatus |
| 12 | container |
| 14 | container sidewalls |
| 16 | container base |
| 18 | handle |
| 20 | basket insert |
| 22 | top basket frame |
| 24 | bottom basket frame |
| 26 | sidewall mesh |
| 28 | bottom mesh |
| 30 | basket handle |
| 32 | side bracket |
| 34 | bottom bracket |
| 36 | clip |

### DETAILED DESCRIPTION

### FIGS. 1, 3, 4A and 4B—Preferred Embodiment

FIG. 1 shows a perspective view of the embodiment while FIGS. 3, 4A and 4B show the two components that comprise the embodiment. Referring to FIG. 3, the container 12 has four container sidewalls 14 and a container base 16. Joined to the container sidewalls 14 on two adjacent sides are handles 18. The material of the container 12 can consist of aluminum, stainless steel, or any other food-grade material meant for use on a stovetop burner.

Referring to FIGS. 4A and 4B, the basket insert 20, consists of a top basket frame 22, bottom basket frame 24, sidewall mesh 26, bottom mesh 28, a basket handle 30, a side bracket 32, a bottom bracket 34, and a clip 36.

In FIGS. 4A and 4B, the bottom bracket 34 is joined to the bottom basket frame 24 at adjacent ends and to the bottom mesh 28. The side bracket 32 is joined to the bottom basket frame 24, is joined to the top basket frame 22, is joined to the sidewall mesh 26. The clip 36 is joined to the side bracket 32. The basket handle 30 is joined to the side bracket 32 near the top and is angled for easier handling. The sidewall mesh 26 is joined to the top basket frame 22, is joined to the bottom basket frame 24, is joined to the side bracket 32. The bottom mesh 28 is joined to the bottom basket frame 24, is joined to the bottom bracket 34.

The material of the basket insert 20 can consist of stainless steel or any other food-grade material meant for use in hot liquids.

### Operation—FIGS. 1 and 2

The food warmer and cooker apparatus with basket inserts operates manually by a cook or other kitchen worker. The container 12 can hold one or more basket inserts 20.

The container 12 may be carried to a sink by the handles 18 or set on a stovetop burner. Water may be poured in from another pot or some other water source. The container 12 should be partially filled with water (or another liquid if desired) to a point that it will not overflow when foodstuff or other items are placed inside the container 12. Once the correct amount of liquid is in the container 12 and the cook is ready to warm or cook foodstuff, the container 12 should be heated on a stovetop burner. Once the liquid in the container 12 reaches the desired temperature, it is ready to warm and cook foodstuff.

Foodstuff to be warmed or cooked is placed in the basket insert 20. Using the basket handle 30, the basket insert 20 is placed inside of the container 12 so that hot liquid passes through the sidewall mesh 26 and bottom mesh 28 of the basket insert 20 and comes in contact with foodstuff (FIG. 2).

Once the cook decides the foodstuff is ready, the basket insert 20 is lifted out of the container 12 by the basket handle 30 and may be securely set to rest on the rim of the container 12 by the clip 36 (FIG. 1). In this position (FIG. 1), liquid may drain through the sidewall mesh 26 and the bottom mesh 28 of the basket insert 20. The basket insert 20 may also be held over the container 12 while the liquid drains through the sidewall mesh 26 and the bottom mesh 28.

Once the cook has decided that enough of the liquid has drained from the basket insert 20, the foodstuff may be transferred to a plate, frying pan, baking dish, or any other place the cook needs to transfer the warmed or cooked foodstuff.

When the basket insert 20 is empty, it may be placed inside of the container 12 (FIG. 2), secured to the rim of the container 12 by the clip 36 (FIG. 1), or refilled with foodstuff where the above mentioned warming and cooking process can be repeated.

When the cook is finished using the food apparatus 10 for the day, the stovetop burner should be turned off and the liquid inside of the container 12 allowed to cool. The liquid should be disposed of properly and the food apparatus 10 handled with care and moved by the handles 18 using oven mitts or some other device used for transferring hot cooking pots and pans.

### ADVANTAGES

From the description above, a number of advantages of some embodiments of our food warmer and cooker apparatus with basket inserts become evident:

(a) The food warmer and cooker apparatus with basket inserts only requires a single stovetop burner to operate—no modifications to the kitchen's layout are necessary.

(b) Two handles on the food apparatus make it easy to transfer from sink to stovetop and back, in addition, it can easily be transferred to another burner to accommodate the cook's stovetop needs.

(c) The basket insert(s) face towards the cook, making it more convenient to remove or return them in a fast-paced environment.

(d) Multiple basket inserts can be placed side by side in the container, allowing for larger quantities of food to be warmed and cooked.

(e) A sturdy clip on the basket insert allows the basket insert to be securely and easily affixed to and removed from the container's rim.

(f) The basket insert's handle is angled so that it is easier for the cook to use, in cases where the basket would need to be tilted, such as times where food is poured onto a plate.

(g) The basket insert has fine holes/mesh that allow water to drain, while at the same time allowing thin foods to remain inside of the basket insert.

### CONCLUSION, RAMIFICATIONS, AND SCOPE

Accordingly, the reader will see that the food warmer and cooker apparatus with basket inserts can be used by any restaurant to meet its needs for warming and cooking foodstuff. The combination of the container and basket inserts allow users to quickly and easily set the basket inserts into hot liquid and when ready, remove the basket inserts and rest them on the rim of the container. The direction of the basket inserts is convenient and reduces the likelihood that the basket insert handles will become overheated from adjacent stovetop burners.

While the description above contains many specificities, these should not be construed as limitations on the scope of any embodiment, but as exemplifications of various embodiments thereof. Many other ramifications and variations are possible within the teachings of the various embodiments. For example, the container can have other shapes, such as slightly rounded corners. The basket inserts can have additional support brackets to strengthen the basket insert.

Thus the scope should be determined by the appended claims and their legal equivalents, and not by the examples given.

We claim:

1. A portable cooking apparatus comprising:
(a) a cooking container with a plurality of sidewalls, a bottom for making contact with a stovetop burner, handles for carrying said cooking container, said cooking container for holding liquid that is heated by a stovetop burner, and basket inserts for warming and cooking a plurality of different foodstuff at the same time,
(b) means for joining said handles to outer said sidewalls of said container for portability,
(c) a top frame for said basket inserts,
(d) a bottom frame for said basket inserts,
(e) a bottom bracket connected to said bottom frame of said basket inserts,
(f) a side bracket connected to said top frame and said bottom frame of said basket inserts,
(g) an angled clip mounted to said side bracket of said basket inserts,
(h) a straight handle mounted to said top frame and said side bracket of said basket inserts,
(i) a mesh bottom mounted to said bottom frame and said bottom bracket of said basket inserts,
(j) mesh sidewalls mounted to said top frame, said bottom frame, and said side bracket of said basket inserts.

2. The basket inserts of claim 1 wherein a food-grade said mesh material with holes allows liquid to enter and escape said basket insert, said mesh material holds thin and thick foodstuff inside said basket inserts.

3. The basket inserts of claim 1 wherein said straight handles point in the direction of the operator when said basket inserts are resting on said sidewall rim of said container.

4. The basket inserts of claim 1 wherein said straight handles point in the direction of the operator when said basket inserts are placed inside said container.

5. A method of warming and cooking foodstuff, comprising:
(a) providing a cooking container with a plurality of sidewalls and a bottom for warming and cooking foodstuff whereby liquid is placed inside said cooking container and heated on a stovetop burner,
(b) providing basket inserts covered with a food-grade mesh material with an opening on top, a straight handle for handling said basket inserts, an angled clip for resting said basket inserts on said cooking container said sidewall rim,
(c) providing said basket inserts' said straight handles point in the direction of the operator while in use,
(d) inserting foodstuff into said basket inserts, whereby said basket inserts are placed inside of heated liquid in said cooking container,
(e) removing said basket inserts from said cooking container and attaching said angled clip to said cooking container said sidewall rim, whereby liquid may drain from said basket inserts and into said cooking container.

6. A method of warming and cooking a plurality of foodstuff, comprising:
(a) providing a plurality of said basket inserts, whereby individual said basket inserts can hold different foodstuff,
(b) providing a plurality of said basket inserts fit inside of said container, whereby a plurality of foodstuff can be warmed and cooked at the same time.
